(19) United States
(12) Patent Application Publication
(10) Pub. No.: US 2005/0197059 A1
(43) Pub. Date: Sep. 8, 2005

(54) Information processing system, terminal unit, recording device, information processing method, program thereof and recording medium storing the program

(75) Inventors: Yukio Numakami, Tokorozawa-shi (JP); Motooki Sugihara, Tokorozawa-shi (JP); Koji Matsuura, Tokorozawa-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: PIONEER CORPORATION, Tokyo (JP)

(21) Appl. No.: 11/033,449

(22) Filed: Jan. 12, 2005

(30) Foreign Application Priority Data
Jan. 14, 2004 (JP) 2004-6852

(51) Int. Cl. H04H 1/00

(52) U.S. Cl. 455/3.02; 455/3.04; 455/456.3; 342/357.1

(57) ABSTRACT

A recording system (100) has a terminal unit (300), a recording device (400) for recording a broadcast program, and a network (200) connecting the terminal unit (300) and the recording device (400) to enable communication therebetween. The terminal unit (300) is provided with a storage for storing geographic information, and a communication line connecting section (310) transmitting destination information indicating a specific position in the geographic information to the recording device (400) through the network (200). The recording device (400) is provided with a network interface (440) for receiving the destination information transmitted from the terminal unit (300), the program associated information acquirer (472) for acquiring program associated information related to the broadcast program, and a timer recording unit (473) acquiring a target program information from the program associated information based on the received destination information.

### BACKGROUND OF THE INVENTION

1. Field of the Invention

The present invention generally relates to an information processing system for processing information based on request information for processing information, a terminal unit, a recording device, an information processing method, a program thereof and a recording medium storing the program

2. Description of Related Art

Conventionally, there has been known a digital TV system or a car navigation device enabling users to set the driving route of such travel destination to which users wish to travel while they are watching a program dealing with a specific geographical location (refer to Japanese Unexamined Patent Publication No. JP2001-197329, p. 8, right column). These systems allow data transmission at a digital TV system and a car navigation device respectively including a remote control device and a TV device through a communication unit. Actuation of remote control device and TV device allows TV system to transmit program associated information to the car navigation, which causes driving route to be set using the location specifying geographical data contained in the program associated information.

In the above reference document, since the geographical location of a travel destination to which users desire to travel is identified while watching a program with TV system, in the event that e.g. there is already determined a travel destination to which users desire to travel, there has been a need for users to examine the destination on a program list beforehand, or to examine the program IDs indicated on the program associated information by users themselves in order to record the program on an automatically-recordable video recorder after recognizing the program associated information to be broadcasted from a station and retrieving the program desired by the user.

Thus, there has been a need to discover the required program out of enormous amount of program lists or the program associated information, with the result that cumbersome labor has been necessitated.

### SUMMARY OF THE INVENTION

An object of the present invention is to provide an information processing system, a terminal unit, a recording device, an information processing method, a program thereof and a recording medium storing the program capable of facilitate recording of the desired broadcast programs.

According to an aspect of the present invention, an information processing system includes: a terminal unit; a recording device for recording a broadcast program; and a communicator for connecting the terminal unit and the recording device to enable communication therebetween, in which the terminal unit includes: a geographic information storage for stores geographic information; and a transmitter for transmitting geographic identifying information indicating a specific position within the geographic information to the recording device through the communicator, and in which the recording device includes: a receiver for receiving the geographic identifying information transmitted from the terminal unit; a broadcast program information acquirer for acquiring broadcast program information related to the broadcast program; and a target program information acquirer for acquiring target program information from the broadcast program information based on the received geographic identifying information.

According to another aspect of the present invention, a terminal unit adapted to be connected with a recording device recording broadcast program through a communicator includes: a geographic information storage for stores geographic information; and a transmitter for transmitting geographic identifying information to the recording device through the communicator, the geographic identifying information indicating a specific position within the geographic information and being used for the recording device to acquire target program information from information related to the broadcast program information.

According to still another aspect of the present invention, a recording device connected with the terminal unit of the present invention through a communicator, in which the recording device includes: a receiver for receiving geographic identifying information to be acquired and to be transmitted by the terminal unit; a broadcast program information acquirer for acquiring broadcast program information related to the broadcast program; and a target program information acquirer for acquiring target program information from the broadcast program information based on the received geographic identifying information.

According to yet another aspect of the present invention, an information processing method includes the steps of: acquiring geographic identifying information indicating a specific position from geographic information at a terminal unit; transmitting the received geographic identifying information from the terminal unit to a recording device through a communicator; and acquiring broadcast program information related to a broadcast program, and then acquiring target program information from the broadcast program information based on the received geographic identifying information in the recording device.

According to further aspect of the present invention, an information processing program causes a computer to execute the information processing method of the present invention.

According to still further aspect of the present invention, a recording medium stores the information processing program of the present invention in a manner readable by the computer.

### BRIEF DESCRIPTION OF THE DRAWINGS

FIG. 1 is a block diagram illustrating schematically a video recording system in accordance with an embodiment of the present invention;

FIG. 2 is a block diagram illustrating schematically a terminal unit;

FIG. 3 is a conceptual diagram illustrating schematically a table structure of display data which constitute map information;

FIG. 4 is a conceptual diagram illustrating schematically a table structure of matching data which constitute the map information;

FIG. 5 is a conceptual diagram illustrating a table structure of point information related to each point of the map information;

FIG. 6 is a block diagram illustrating a structure of a processor of the terminal unit;

FIG. 7 is a conceptual diagram illustrating a table structure of destination information;

FIG. 8 is a view illustrating one example of screen display displayed on a terminal display as display unit;

FIG. 9 is another view illustrating one example of screen display displayed on the terminal display, as display unit;

FIG. 10 is a conceptual diagram illustrating recorded contents information used in the display screen of FIG. 9;

FIG. 11 is a block diagram illustrating schematically a recording device;

FIG. 12 is a conceptual diagram illustrating a data structure stored in the recording medium of the recording device;

FIG. 13 is a conceptual diagram illustrating the keyword information grouping as a part of the data structure shown in FIG. 12;

FIG. 14 is a conceptual diagram illustrating the timer recording information group as a part of the data structure shown in FIG. 12;

FIG. 15 is a conceptual diagram illustrating recorded program information group as a part of the data structure shown in FIG. 12;

FIG. 16 is a block diagram illustrating CPU structure of the recording device;

FIG. 17 is a flow chart that generates destination information in the terminal unit;

FIG. 18 is a flow chart showing a generation processing of keyword information in the recording device;

FIG. 19 is the flow chart showing a timer recording processing of broadcast programs in the recording device;

FIG. 20 is a flow chart showing processing of recorded program information in the recording device; and

FIG. 21 is a flowchart for generating the destination information in a modification of the present invention.

### DETAILED DESCRIPTION OF PREFERRED EMBODIMENT(S)

An embodiment of the present invention will be described below, with reference to the attached drawings. Although in the following exemplary embodiment, explanation is given about a video recording system as a system for information processing that receives, at a recorder as a recording device, the geographic information of the destination from a terminal unit, but the system is not limited to this exemplary embodiment. That is, there is also available as an information recording device a sound recorder adapted to set timer for sound recording of a radio program. As the terminal unit, for instance, a navigation device, a personal computer equipped with application software that serves geographical information using map information, or other various kinds of devices are also available. Moreover, there may be adopted a configuration enabling processing of any information such as image data or programs and the like in the same manner.

[Configuration of Information Processing System]

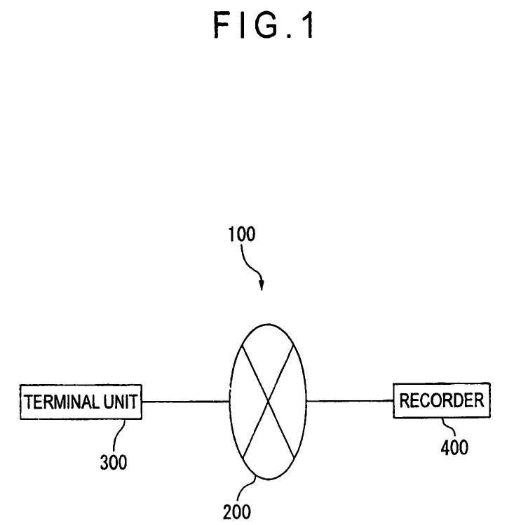

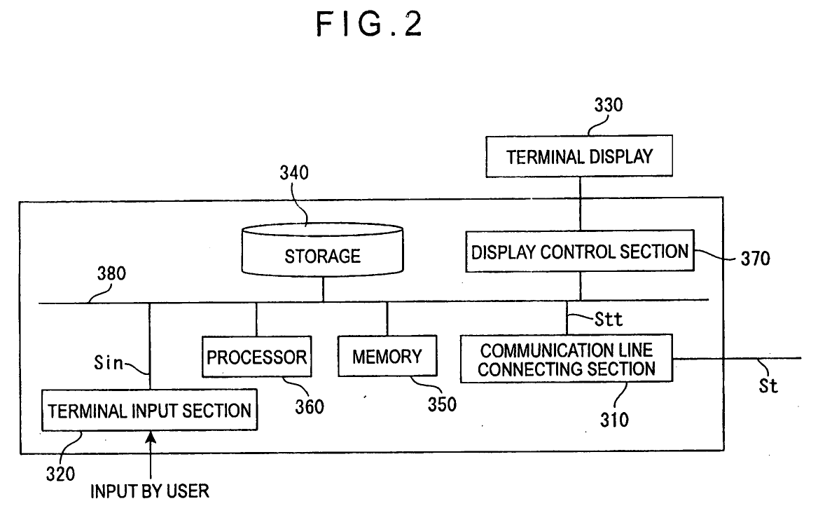

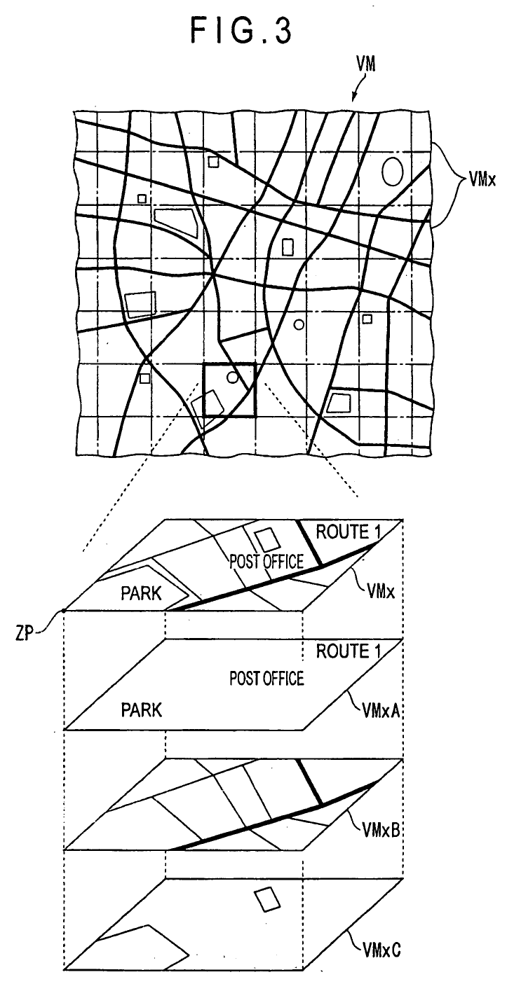

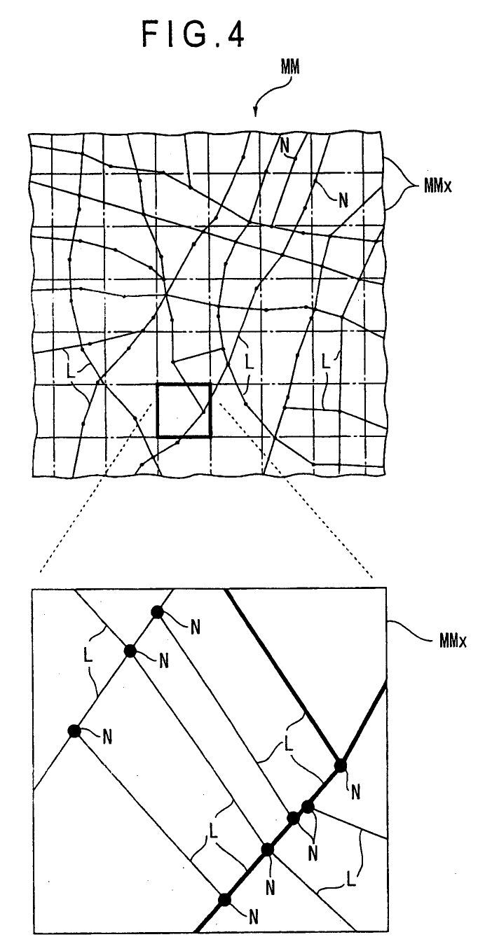

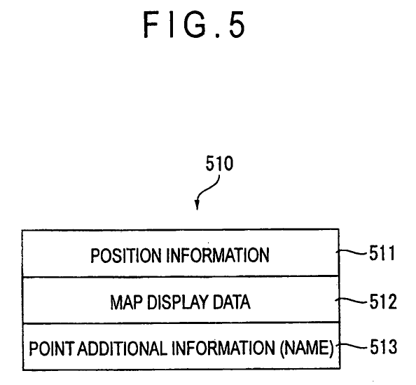

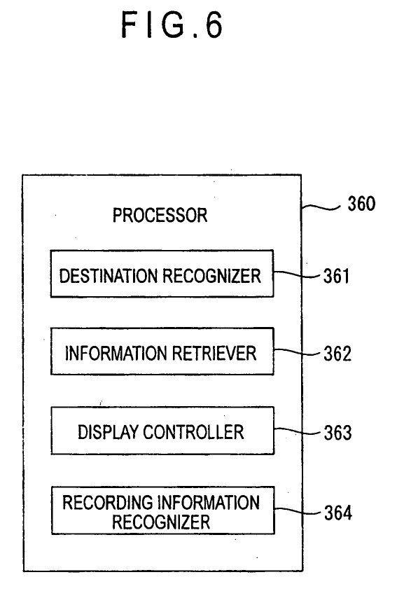

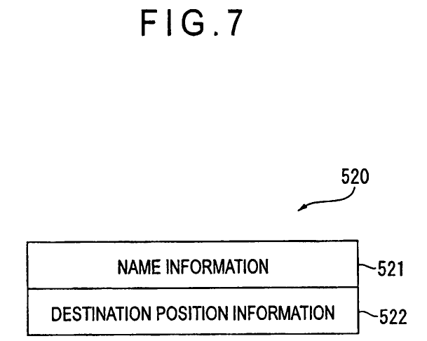

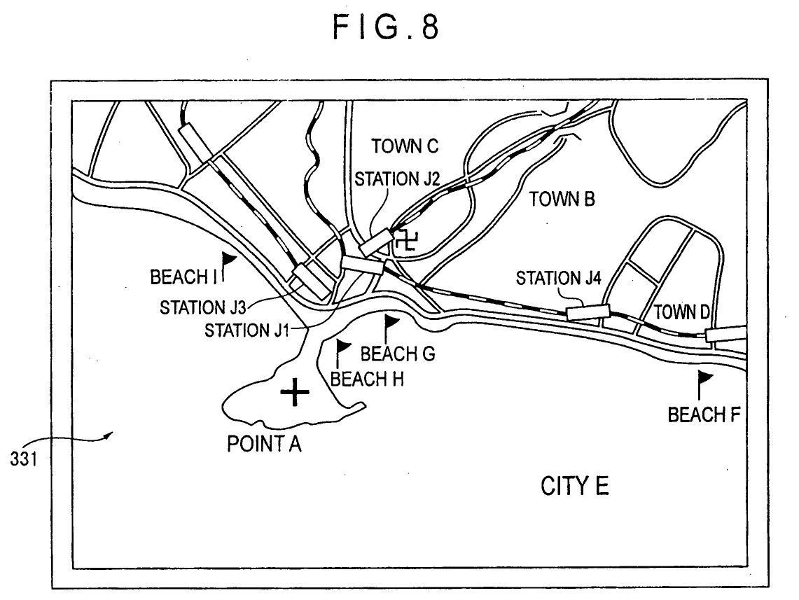

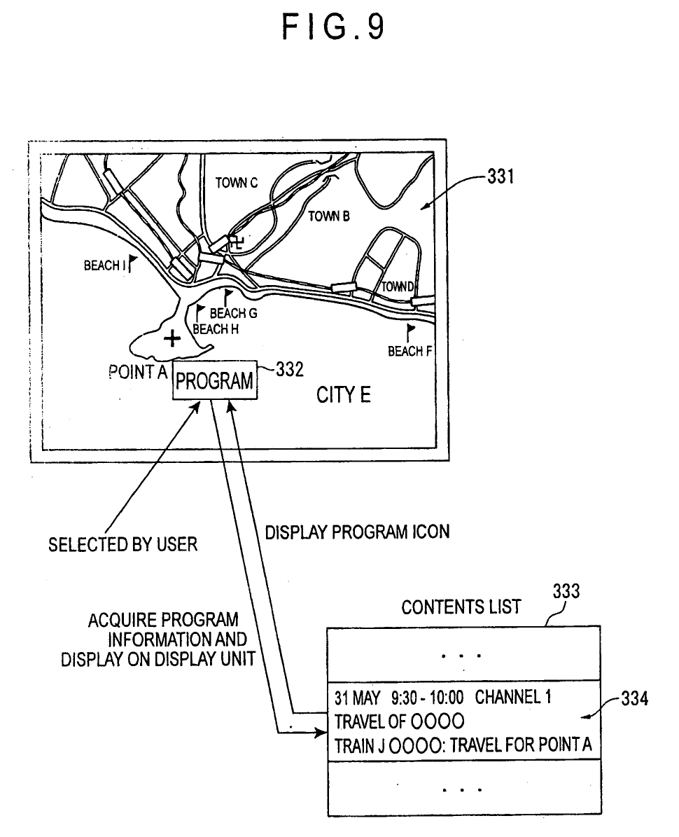

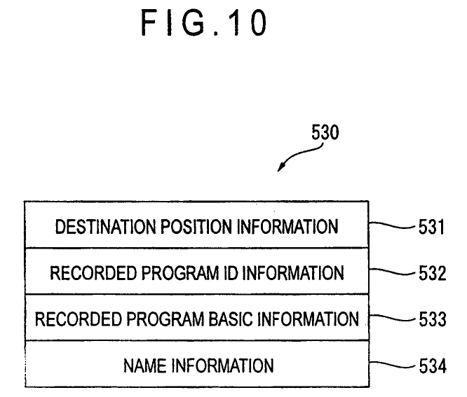

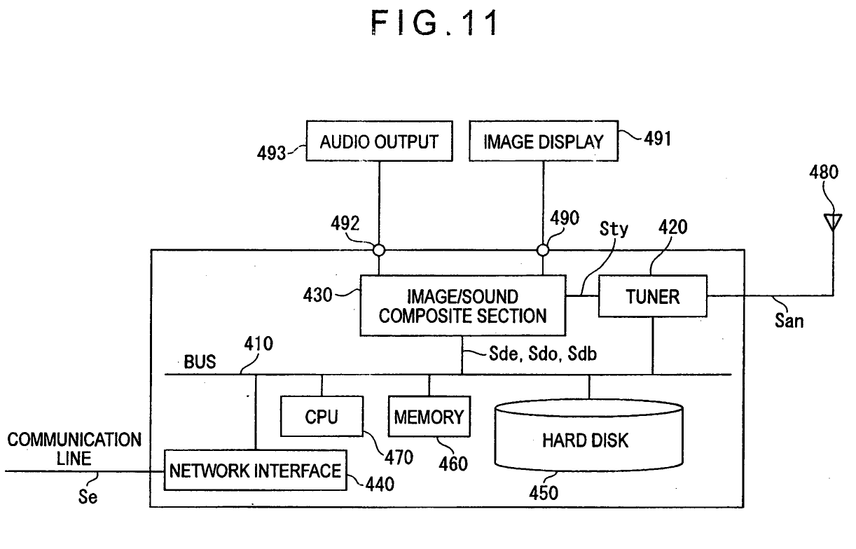

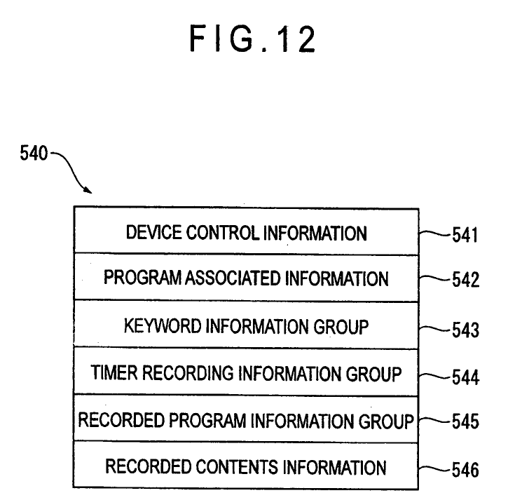

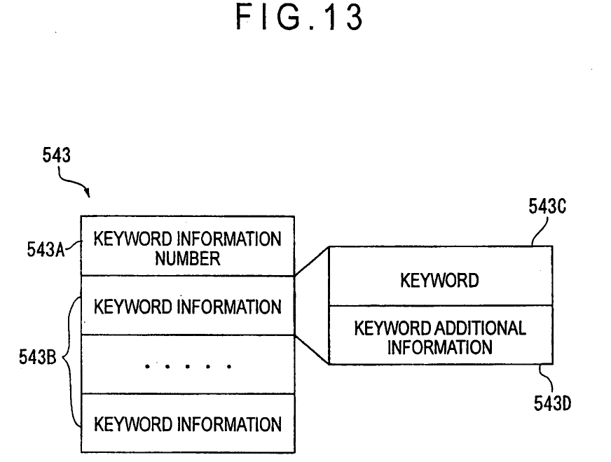

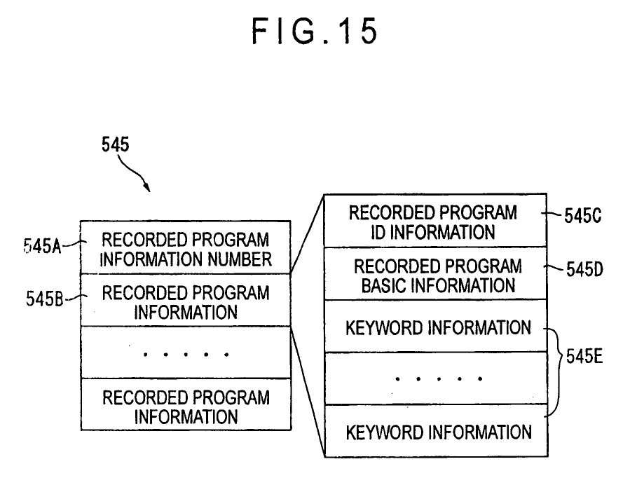

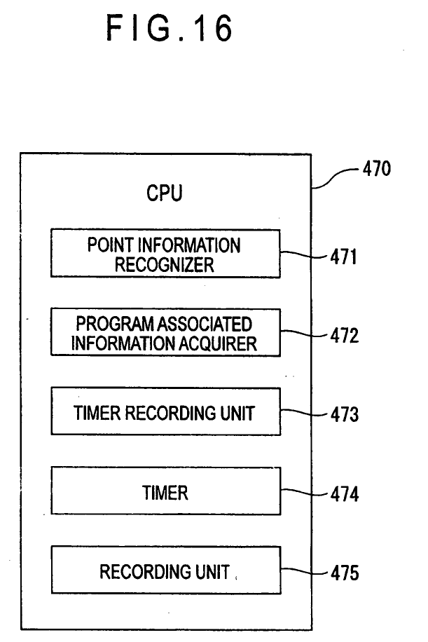

With reference to FIG. 1 to 16 a configuration of a recording system of the present embodiment will be described. FIG. 1 is a block diagram illustrating schematically the recording system. FIG. 2 is a block diagram illustrating schematically a terminal unit. FIG. 3 is a conceptual diagram illustrating schematically a table structure of display data which constitute map information. FIG. 4 is a conceptual diagram illustrating schematically a table structure of matching data which constitute map information. FIG. 5 is a conceptual diagram illustrating a table structure of point information related to each point of the map information. FIG. 6 is a block diagram illustrating a structure of a processor of the terminal unit. FIG. 7 is a conceptual diagram illustrating a table structure of destination information. FIG. 8 is a view illustrating one example of screen display displayed on a terminal display as display unit. FIG. 9 is another view illustrating one example of screen display displayed on the terminal display as display unit. FIG. 10 is a conceptual diagram illustrating recorded contents information used in the screen display of FIG. 9. FIG. 11 is a block diagram illustrating schematically of a recorder. FIG. 12 is a conceptual diagram illustrating a data structure stored in a recording medium of the recorder. FIG. 13 is a conceptual diagram illustrating a keyword information group as a part of the data structure shown in FIG. 12. FIG. 4 is a conceptual diagram illustrating a timer recording information group as a part of the data structure shown in FIG. 12. FIG. 15 is a conceptual diagram illustrating a recorded program information group as a part of the data structure shown in FIG. 12. FIG. 16 is a block diagram illustrating a CPU structure of the recorder.

In FIG. 1, a numeral 100 is a recording system as information processing system. This recording system 100 has a network 200 as a communicator, a terminal unit 300 and a recorder 400 as a recording device.

Terminal unit 300 and the recorder 400 are connected to the network 200 so that information can be transmitted to and received from the network 200. Such networks as internet, Intranet or LAN (Local Area Network), based on general protocols like TCP/IP, and networks such as communication line network and broadcast network in which multi-stations allowing transmission and reception of information through radio media configure the network, can be given as examples. Moreover, the radio media themselves as media for directly transmitting and receiving information between the terminal unit 300 and the recorder 400 can also be exemplified. As the radio media, electronic waves, optical, sonic or electromagnetic wave can be used. FIG. 1 illustrates only one terminal unit 300 and one recorder 400, but these can be connected to multiple networks as well.

[Configuration of Terminal Unit]

The terminal unit 300 may be, for example, in-vehicle type installed in a vehicle as a mobile body, a portable type, a PDA (Personal Digital Assistant), a cellular phone a PHS (Personal Handy-phone System), a personal computer. As shown in FIG. 2, the terminal unit 300 includes a communication line connecting section 310 used as a transmitter, a terminal input section 320 as an input unit, a terminal display 330 used as display unit, a storage 340 as a geographic information storage, a memory 350, a processor 360 and a display control section 370.

A bus 380 can be a PCI (Peripheral Component Interconnect) bus or an IEEE (institute of Electrical and Electronic Engineers) 1394 bus. The communication line connecting section 310, the terminal input section 320, the storage 340, the memory 350, processor 360, the display control section 370 and others, are connected to the bus 380.

The communication line connecting section 310 is connected to the recorder 400 through network 200, and also to processor 360 through the bus 380. Communication line connecting section 310 can receive the terminal signal St from the recorder 400 through the network 200. By receiving the terminal signal St, the communication line connecting section 310 implements the preset interface input processing, and outputs as processing terminal signal Stt to the processor 360. In communication line connecting section 310, the processing terminal signal Stt can be input from processor 360, and by receiving the input processing terminal Stt, the communication line connecting section 310 implements the preset output interface processing, thus sending the terminal signal St to the recorder 400 through network 200.

The terminal input section 320 is provided with input devices such as a keyboard or mouse (Not shown) for input operation. This terminal input section 320 is connected with processor 360 through the bus 380. As input operation with actuation keys, there are such setting items as the definition of operation content of the terminal unit 300, i.e. the display of destination definition, information search, or the running conditions showing the moving state of the vehicle, for example. More precisely, through inputting operation of defined items, terminal input section 320 creates outputs and definition of specific signal Sin towards processor 360. For the terminal input section 320, input actuation is not limited to operation keys. For the items definition input the terminal input section 320 can be configured with such input operations as the touch panel fitted in terminal display 330, or the voice input for example.

The terminal display 330 is controlled by the processor 360 and displays a signal Sdp of image data from the processor 360. The image data includes such image data as search information or map information as the geographic information referred to hereafter and stored in the storage 340, TV image data received through a TV receiver (Not shown), image data related to information transmitted from the recorder 400, image data recorded in a recording medium such as external devices like optical or magnetic discs and read by drive, and image data emitted from the memory 350, and the like. More specifically, the terminal display 330 can be a liquid crystal or an organic EL (Electroluminescence) panels, a PDP (Plasma Display Panel) or a CRT (Cathode-Ray Tube), etc.

The storage 340 stores, for example, the map information as the geographic information illustrated in FIGS. 3 and 4 or the recorded program information referred to hereafter, in other words the storage 340 readably stores the information appropriately.

The storage is connected to the processor 360 through the bus 380. The storage 340 includes, although not shown, a map information storage area for storing the map information, a point information storage area for storing the point information and a recorded program information storage area for storing recorded program information, etc. Here, a configuration in which the storage 340 is equipped with three of the storage areas is exemplified, but the configuration is not limited thereto. For example, such configurations as the one without above mentioned storage areas or the one equipped with extra storage areas may also be employed. As the storage 340, drives or drivers which readably store information on a recording medium such as a HD (Hard disk), a DVD (Digital Versatile Discs), an optical disc or a memory card can be exemplified.

The map information is used in such processes as the search process for self routing when searching among multiple routes or in the map display process. The map information includes, for example, a display data VM, which is so called POI (Points Of Interest) data as shown in FIG. 3, or a matching data MM as shown in FIG. 4, a route search map data, and the like.

The display data VM includes a plurality of display mesh information VMx, each having a unique number. This means that the display data VM are divided into a plurality of display mesh information VMx, each relating to an area, and that the display mesh information VM are continuously arranged in a matrix form. In addition to the above, the display mesh information VMx can be further divided into a plurality of display mesh information VMx to be contained in a lower layer related to a specific area. Each display mesh information VMx has a rectangular shape with each side thereof having a predetermined length, which is reduced relative to the actual geographic length according to the map scale. A predetermined corner thereof contains absolute coordinates ZP in the whole map information, e.g., a global map.

In addition to the above, the display mesh information VMx contains name information VMxA such as the name of intersections, road information VMxB, and background information VMxC. The name information VMxA is configured into a table structure which arranges and displays miscellaneous element data (e.g. the name of junctions or the name) of a specific area at a predetermined position with reference to the positional relationship based on the absolute coordinates ZP. The Road information VMxB is configured into a table structure which arranges and displays a road as a road element data of a specific area at a predetermined position with reference to the positional relationship based on the absolute coordinates ZP. The background information VMxC is configured into a table structure, which arranges and shows miscellaneous element data (e.g. mark and image information representing famous spots and buildings) at a predetermined position with reference to the positional relationship based on the absolute coordinates ZP.

On the other hand, the matching data MM, as the display data VM, are divided into a plurality of matching mesh information MMx each having unique number related to an area, and the matching mesh information MMx are arranged in a matrix form. Furthermore, the matching mesh information MMx may further be divided into MMxs contained in a lower layer related to a specific area. Each matching mesh information MMx has a rectangular shape with each side thereof having a predetermined length, which is reduced relative to the actual geographic length according to the map scale. A predetermined corner thereof contains absolute coordinates ZP in the whole map information, e.g., a global map. Moreover, the matching mesh information MMx may have a data structure showing an area different from the display mesh information VMx, that is, the divided area may have different scales. If the scales are identical, the data may be associated by using unique number information, and if the scales are different, the data may be associated by using absolute coordinates, for example.

The matching data MM has a plurality of link string block information. As shown in FIG. 3, the link string block information is data structure in a table so that a plurality of link L representing roads and connecting nodes N as the point information are mutually associated according to a predetermined rule. More specifically, for such roads which have a specific length of the road, for example such continuous roads as Koshu street or Ohme street, links L are continuously and mutually connected as link string. Thus, the links L contain a unique segment information (referred to hereafter as link ID) as a unique number affixed to each link L, and a node information such as a unique number showing the two nodes connected by one link L.

The node N corresponds to a joint point, such as an intersection, a corner, a fork, a junction, or the like. Information related to nodes N contain unique point information i.e. a unique number appended to each node N in link string block information, coordinate information of a position where each node N is located, and flag information as branching information describing whether the node N is a branching position (i.e. intersection or fork) where a plurality of links are crossed or not. Further, the nodes N include the one only having the unique point information and the coordinate information without the flag information for only showing a shape of the road, and the one having attribute information showing a structure of the road such as the width of tunnels or roads, for example.

Furthermore, in the link string block information of the matching data MM, information related to the structure of the road are associated, the structure including, for example, road category such as number of lanes, main road or not, national or prefectural road, toll road, or road structure such as inside tunnel. Based on the information related to the road structure, the road can be indicated on a map corresponding to the display data VM.

Furthermore, the route search map data is a data structured in a table structure similar to the matching data MM, in which the point information as the geographic identifying information showing the points like the node N showing the road, as well as the segment information connecting different points like the link L are included. The route search map data has an information structure for showing the road in order to search the travel route.

The point information is information formed into a table structure of a data structure as illustrated in FIG. 5. In FIG. 5, point information 510 contains such information as position information 511, map display data 512, point additional information 513. The position information 511 is information showing a position at each point by, for example, longitude and latitude. The map display data are information regarding the map information for displaying a point shown in the position information 511 on the terminal display 330. The point additional information 513 is information storing various kinds of information such as point information, a name of building, and an address shown by the position information 511. The point additional information 513 may contain a plurality of point information shown by the position information 511 or additional information showing a tourism spot situated at the surroundings of the point shown by position information 511.

Additionally, the search information for acquiring specific point information in the map information is stored in the storage 340. That is to say, the search information is configured in a table structure having a tree structure where various item information are positioned hierarchically associated with one another, the item information being related to content such as names of areas consecutively divided into prefectures, cities and towns, districts, and points in the map information or a variety of information for guidance, or a variety of information relating to the name of shops as points.

The memory 350 appropriately stores, e.g., a variety of information acquired through the network 200, the settings inputted by the terminal input section 320, and music data or image data. The memory 350 is connected to the processor 360 through the bus 380. Furthermore, the memory 350 stores a variety of programs run on the OS (Operating System) driving and controlling the entire terminal unit 300. Additionally, the memory 350 may include drives and drivers for readably storing the data on a recording medium such as hard disks or optical discs, for example.

The processor 360 is equipped with various input ports (Not shown), such as a communication port for connecting to the communication line connecting section 310, a key input port for connecting to the terminal input section 320, a display control port for connecting to the terminal display 330 and a storage port for connecting to the memory 350. Then, the processor 360 contains various programs such as a destination recognizer 361 as a geographic information acquirer, an information retriever 362, a display controller 363, a recording information recognizer 364, and the like, as shown in FIG. 6. The processor 360 is equipped with an internal clock, thus allowing acquisition of time information related to current day and time.

Upon input operation of the terminal input section 320 for example, the destination recognizer 361 recognizes position information related to the destination having been set by the input operation. Then, the destination recognizer 361 generates the destination information as position information based on the recognized position information as well as the point information 510, as shown in FIG. 7. In FIG. 7, destination information 520 has a data structure having name information 521 and destination position information 522, for example. In the name information 521, such information as names of a point or a building are written. The name information 521 is generated based on the point additional information 513 of the point information 510. The name information 521 may contain names and buildings of a plurality of point, or may contain information showing tourism spots around the point shown by the position information 511. The destination position information 522 is information related to the position of the destination having been set according to the input operation of the user with the terminal input section, and may include such information as longitude and latitude, for example. Then, the destination information is stored in the storage 340.

The information retriever 362 acquires a variety of information correspondingly associated with the search information stored in the memory 350, based on the search information out of information acquired by setting operation at the terminal input section 320. That is, the item information to be retrieved is displayed on the terminal display 330 by using a list screen, a number key screen for inputting a numeric value like numbers, and a character input screen for inputting characters such as Japanese alphabet and English alphabet. Then the memory 350 appropriately acquires the hierarchically arranged item information with the input operation at the terminal input section 320. In this way, the information is retrieved.

The display controller 363 controls terminal display 330 suitably and causes various information to be displayed on the terminal display 330. The control of the display controller 363 allows the various screen displays to retrieve information at the information retriever 362.

FIG. 8 shows one example of screen display on the terminal display 330 caused to be displayed by the display controller 363. In FIG. 8, the map information 331 is, for example, a display of the map information around the city E. In this map information, point A, town B, town C, town D, beach F, beach G, beach H, stations J1 to J4 are displayed. For example, it is assumed that the point A is selected by user's input operation on the screen. At this time, the destination recognizer 361 recognizes the position information with longitude and latitude regarding the point A—described therein, and generates the destination position information 522. Thereupon, based on the point additional information 513 of the point information 510, the destination recognizer 361 generates the name information 521 with the information as names of the point A or building and the like described therein. As mentioned above, the name information 521 may have information of such as names of surrounding areas and buildings or, tourism spots in the vicinity of the point A, that is, the name information 521 may contain such name information as the beach H or the station J3 situated near point A.

The recording information recognizer 364 recognizes the later-described recorded programs transmitted from the recorder 400. Then, when the recording information recognizer 364 recognizes the recorded program information, it causes the terminal display 330 to execute a process to display the information indicating that the information on the destination has been recorded by the recorder 400 on the terminal display 330, as shown in FIG. 9. To be more specific, when the recording information recognizer 364 recognizes the recorded program information, it causes, for example, the display of program confirmation icon 332 on the map information 331 having been displayed on the screen at the terminal display 330 near a position based on the destination position information 522 of the destination information 520 generated by the destination recognizer 361. Although, in the above description, the display of the program confirmation icon 332 is employed, the configuration is not limited thereto, and the information prompting a user to confirm the program may be displayed by other display methods such as text boxes and the like, or such display may also be omitted.

Furthermore, the recording information recognizer 364 generates contents list information 530 based on the recorded program information as shown in FIG. 10. The contents list information 530, as shown in FIG. 10, includes a data structure containing, e.g., destination position information 531, recorded program ID information 532, recorded program basic information 533, name information 534, etc. The destination position information 531 is information generated based on the destination position information 522 recognized by the destination recognizer 361. To be more specific, the destination position information 531 contains information regarding a position such as longitude and latitude of the destination. The recorded program ID information is unique information for, for example, identifying each program recorded by the recorder 400. The recorded program basic information is information showing, for example, the broadcasting time, name and the channel of the programs recorded by the recorder 400. The name information 534 shows names of each point and building and is generated based on the name information 521 of the destination information 520 generated by the destination recognizer 361.

Then, when the recording information recognizer 364 recognizes the input made by the user in order to select the program identification icon from the terminal input section 320, the recording information recognizer 364 deploys the recorded program information and causes the display controller 363 to execute a process to display the described content as contents list 333, based on the contents list information 530. The contents list 333 is displayed by arranging a plurality of contents information 334 in parallel, the contents information 334 being displayed based on the later-described recorded program basic information.

The display control section 370 is controlled by the processor 360, and sends the image data signal Sdp from the processor 360 to the terminal display 330 to the display on the screen. In addition to the map information as the later-described geographic information and the retrieval information stored in the storage 340, the image data include a TV image data received by a TV receiver (not shown), those related to the information transmitted from the recorder 400, those stored in an external device or a recording medium such as optical disc or magnetic disc and read by a drive and those form the memory 350. The display control section 370 is connected to the processor 360 through the bus 380.

[Configuration of Recorder]

The recorder 400 executes recording and playback of the TV program based on the destination information transmitted form the terminal unit 300. The recorder 400, as shown in FIG. 11, includes a bus 410, a tuner 420 as a broadcast program acquirer, an image/sound composite section 430, a network interface 440 as a receiver, a hard disk 450 as a recording medium, a memory 460, CPU 470, and the like.

As the bus 410, a PCI (Peripheral Component Interface) bus or an IEEE (Institute of Electrical and Electronic Engineers) 1394 bus can be exemplified. Devices such as the tuner 420, the network interface 440, the hard disk 450, the memory 460 and the CPU 470 are connected to the bus 410.

An antenna 480 receiving broadcast wave is connected to the tuner 420. Also, the tuner 420 is connected to the image/sound composite section 430. Furthermore, the tuner 420 is connected to the CPU 470 through the bus 410. Then, the tuner 420 receives a signal San received by and input from the antenna 480 under control of the CPU 470. Then, the tuner 420 appropriately converts the received signal San to a processing signal Sty, and outputs to the image/sound composite section 430.

The image/sound composite section 430 is connected to the hard disk 450 through the bus 410. Furthermore, the image/sound composite section 430 is connected to the CPU 470 through the bus 410. The image/sound composite section 430 receives a processing signal Sty input from the tuner 420, and separates the image data and the audio data contained in the received processing signal Sty and program associated information as program information under control of the CPU 470. Then, the image/sound composite section 430 appropriately converts the image data to a processing signal Sde, and outputs to the hard disk 450. The image/sound composite section 430 appropriately converts the audio data to a processing signal Sdo, and outputs to the hard disk 450. Furthermore, the image/sound composite section 430 appropriately converts the program associated information to a processing signal Sdb, and outputs to the hard disk 450.

Also, the image/sound composite section 430 appropriately converts the received image data to an image signal Se after restoring the data as an image stream, under control of the CPU 470. Then, the image/sound composite section 430 outputs the converted image signal Se to an image display 491 connected to the terminal 490, and displays the image stream on the image display 491. In addition, the image/sound composite section 430 appropriately converts the received audio data to the processing signal So after restoring the data as an audio stream, under control of the CPU 470. Thereafter, the image/sound composite section 430 outputs the converted audio-signal So to an audio output 493 connected to the terminal 492, allows the audio stream to be output from the audio output 493.

The network interface 440 is connected to the terminal unit 300 through the network 200, also is connected to the CPU 470 through the bus 410. The network interface 440 receives a terminal signal St from the terminal unit 300 input through the network 200. After receiving the terminal signal St, the network interface 440 executes preset input interface processing, and then, outputs a process recording device signal Str to the CPU 470. Also, the network interface 440 executes the preset output interface processing by receiving the process recording device signal Str from the CPU 470. Thereafter, the terminal signal St as the execution results is output to the terminal unit 300 through the network 200. The terminal signal St includes, for example, the above-described destination information 520 and recorded program request information. Furthermore, the process recording device signal Str includes, for example, the above-described recorded program confirmation information and the later-described recorded program information, and the like.

The hard disk 450 is connected to the memory 460 and the CPU 470 through the bus 410. The hard disk 450, as shown in FIG. 12, stores a data structure 540 having, for example, a device control information 541, a program associated information 542, a keyword information group 543, a timer recording information group 544 as a timer recording information, a recorded program information group 545, a recorded contents information 546, and the like.

The device control information 541 is related to the various information of the recorder. More precisely, the device control information 541 includes identification information, e.g., an IP address for identifying the recorder 400 and an IP address for the terminal unit corresponding to the recorder 400.

The program associated information 542 is the information acquired by the image/sound composite section 430 and stored in the hard disk 450. Specifically, as the program associated information 542, an EPG (Electric Program Guide) can be exemplified. The program associated information 542 includes information such as a date, start and end time, station channel information and a name of the broadcast program.

The keyword information group 543, as shown in FIG. 13, is information including a keyword information number 543A and keyword information 543B as a data structure. The keyword information number 543A indicates total number of the keyword information 543B. The keyword information 543B includes, for example, the keyword 543C and the keyword additional information 543D. The keyword 543C is information on names of a point or a building related to the destination recognized by the destination recognizer 361 of the terminal unit 300. The keyword additional information 543D is information indicating a position of each point contained in the keyword 543C. More specifically, information regarding a position such as latitude and longitude are contained.

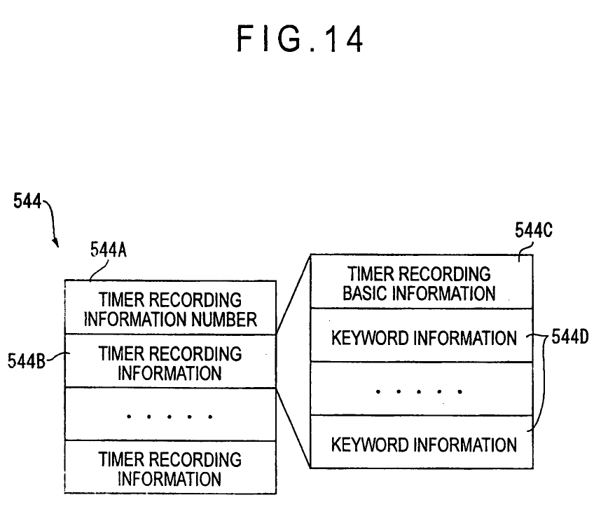

The timer recording information group 544, as shown in FIG. 14, is information having a data structure including timer recording information number 544A and timer recording information 544B as desired broadcast program, and the like. The timer recording information number 544A indicates total number of the timer recording information 544B. The timer recording information 544B includes, for example, timer recording basic information 544C and keyword information 544D. The timer recording basic information 544C includes basic information required for timer recording of TV program. The timer recording basic information 544C, more specifically, includes information related to settings such as a date, start and end time of timer recording, station channel information and a name of the broadcast programs, and image quality. The keyword information 544D is the information related to keyword of the broadcast program being timer recorded. The keyword information 544D is appropriately selected from the keyword information 543B of the keyword information group 543.

The recording program information group 545, as shown in FIG. 15, is the information having a data structure including, for example, the recorded program information number 545A and the recorded program information 545B as recorded program information. The recorded program information number 545A indicates total lumber of the recorded program information 545B. The recorded program information 545B includes, for example, recorded program ID information 545C, the recorded program basic information 545D and keyword information 545E. The recorded program ID information 545C is an identifier provided for each recorded program. The recorded program basic information 545D is the basic information related to the recorded program, including settings such as a date, start and end time of the recording, station channel information of and a name of the recorded program, and image quality. The keyword information 545E is the information related to the keyword indicating the corresponding keywords for the recorded program.

Recorded contents information 546 includes contents of the recorded program. Each of the program contents have unique recorded program ID, and the recorded program ID corresponds one-to-one with the recorded program ID information 545C contained in the recorded program information group 545.

In the present embodiment, although the hard disk 450 is exemplified as a recording unit, but the configuration is not limited thereto, and a video tape or DVD-RAM or other recording media, for example, may also be employed.

The memory 460 is connected to the CPU 470 through the bus 410. The memory 460 readably stores various information such as the timer recording information group 544 stored in the hard disk 450. Furthermore, the memory 460 stores various programs run on the OS (Operating System) controlling the entire recorder 400.

The CPU 470, as shown in FIG. 16, has various programs such as a point information recognizer 471, a program associated information acquirer 472 as a broadcast program information acquirer, a timer recording unit 473 as an intended program acquirer and an intended program timer recording unit, a recorder timer 474 and a recording unit 475 as a target program recording unit and an intended program information recording unit.

The point information recognizer 471 recognizes destination information received from the terminal unit 300, and generates the keyword information 543B from the destination information 520. More specifically, the point information recognizer 471 generates the keyword information 543B based on the name information 521 of the destination information 520, and generates the keyword additional information 543D based on the destination position information 522. Thereafter, the point information recognizer 471 registers the generated keyword information 543B to the keyword information group 543, and then, updates the keyword information number 543A with increasing, e.g., one. In this regard, when the point information recognizer 471 retrieves the keyword information group 543, and finds keyword information 543B identical to the keyword information 543B generated by the destination information 520, the point information recognizer 471, for example, does not register the newly generated keyword information 543B in order to prevent duplication. Furthermore, the keyword information 543B may have keyword registration period information indicating time period being registered in the keyword information group or the keyword information 543B may be so configured to be erased when expired the registration period.

The program associated information acquirer 472 recognizes the program associated information 542 separated off by the image/sound composite section 430. Then, the program associated information acquirer 472 compares the program associated information 542 having been recorded in the hard disk 450 with the newly recognized program associated information 542. Then, when the newly recognized program associated information 542 is determined to be newer, the program associated information acquirer 472 updates the program associated information having been recorded in the hard disk 450. For this comparison, for example, program associated additional information including date generating the program associated information is described in each of the program associated information 542. The program associated information acquirer 472 determines whether the newly recognized program associated information 542 is newer than the program associated information 542 having been recorded in the hard disk, by recognizing the program associated additional information.

The timer recording unit 473 updates the timer recording information group 544 based on the keyword information 543B described in the keyword information group 543. More specifically, the timer recording unit 473 refers to the keyword information 543B registered in the keyword information group 543, and retrieves the program information related to the keyword information 543B from the program associated information 542, for example. If the program information of the program related to the keyword information 543B is described in the program associated information 542, the timer recording unit 473 acquires the program information. Thereafter, the timer recording unit 473 generates the timer recording basic information 544C based on the program information of the program described in the program associated information 542, and then, also generates the keyword information 544D of the timer recording information 544B based on the keyword information 543B in the keyword information group 543. Thereafter, the timer recording unit 473 generates the timer recording information 544B from the timer recording basic information 544C and the keyword information 544D, and resisters to the timer recording information group 544, and increases a timer recording information number, for example, by one. Then, the timer recording unit registers the timer recording information number 544A and the timer recording information 544B, and updates the timer recording information group 544.

The recorder timer 474 recognizes the current time based on the reference pulse of, for example, an internal clock. The recorder timer 474 appropriately outputs time information related to the recognized current time.

The recording unit 475 carries out recording of a broadcast program based on the timer recording information 544B described in the timer recording information group 544 of the recorder 400. More specifically, the recording unit 475 refers to the settings described in the timer recording basic information 544C of the timer recording information 544B, such as a date, start and end time of timer recording, station channel information and a name of the broadcast program, and image quality. Then, the recording unit 475 records contents of the broadcast program when the recording unit 475 determines the current date and time output from the recorder timer 474 matches with the specified date and time. The contents of the broadcast program are recorded as recorded contents information on, for example, the hard disk 450. At this time, a unique recording program ID is allocated to each broadcast program contents.

The recording unit 475 generates the recorded program information 545B of the recorded broadcast program. More specifically, the recording unit 475 generates the recorded program ID information 545C from the recording program ID allocated for each recorded program contents. Then, the recording unit 475 generates the recorded program basic information 545D of the recorded broadcast program based on the timer recording information 544B. In addition, the recording unit 475 generates the keyword information 545E related to the recorded broadcast program based on the keyword information 544D of the timer recording information 544B. Then, the recorded program information 545B is generated based on the recorded program ID information 545C, the recorded program basic information 545D and the keyword information 545E. Also, the number described in the recorded program information number 545A is increased, for example, by one. Then, the recorded program information number 545A and the recorded program information 545B are registered to the recorded program information group 545 and updated. In addition, the recording unit 475 erases the timer recording information 544B related to the recorded broadcast program from the timer recording information group 544.

[Operation of Information Processing System]

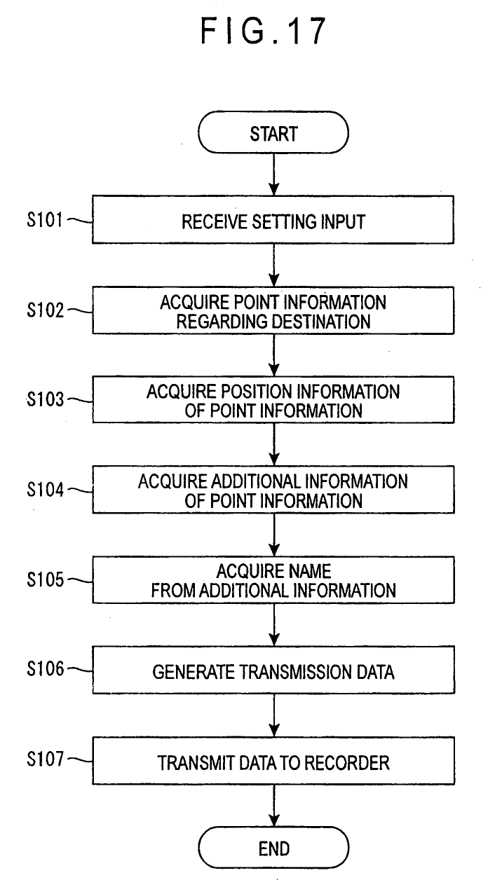

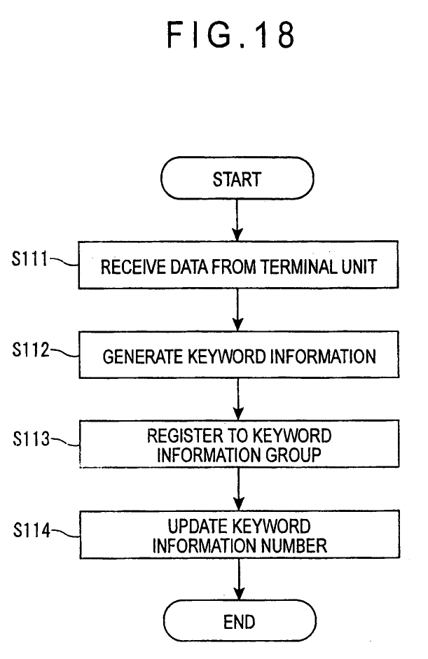

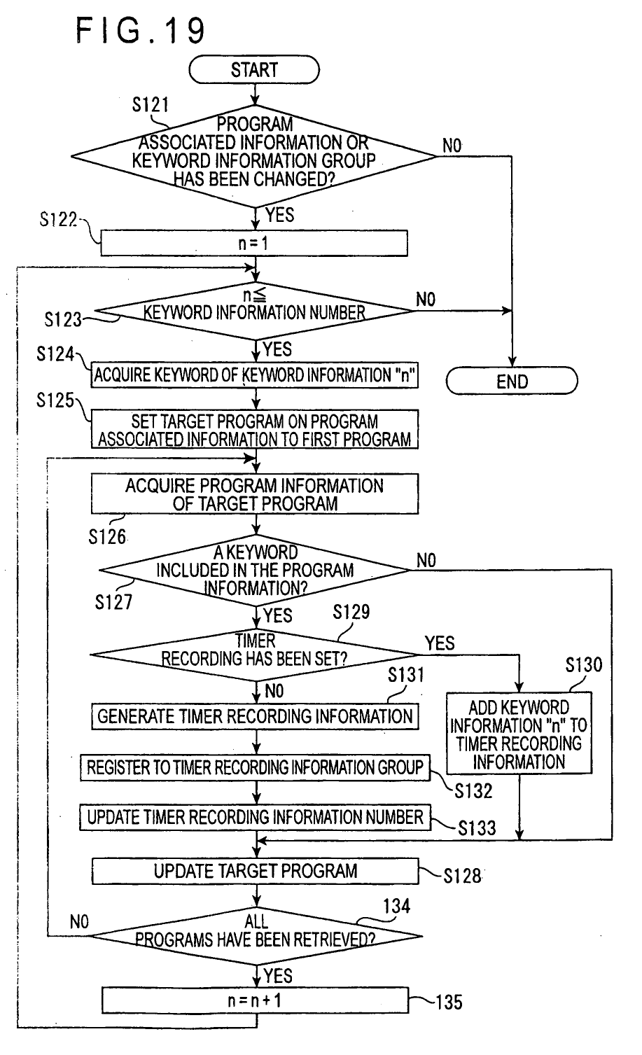

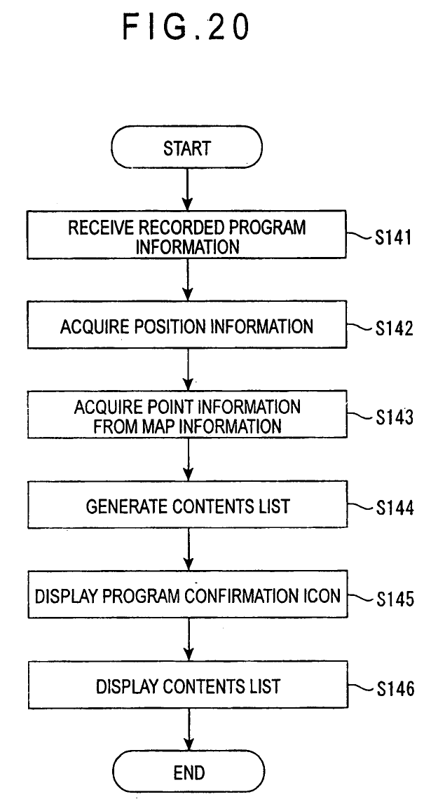

Hereinafter, operation of the video recording system 100 will be described with reference to FIGS. 17 to 20. FIG. 17 is a flow chart showing a generation of destination information by acquiring destination related information in the terminal unit 300. FIG. 18 is a flowchart showing a generation processing of keyword information in the recorder 400. FIG. 19 is a flowchart showing a timer recording processing of a broadcast program in the recorder 400. FIG. 20 is a flowchart showing a processing of recorded program information in the terminal unit 300.

Firstly, the generation processing of the destination information in the terminal unit 300 will be described with reference to FIG. 17.

The terminal unit 300 displays the map information on the terminal display 330 based on the map information stored in the storage 340. A user inputs a setting to set a destination with the terminal input section 320 of the terminal unit 300 for the map information displayed on the terminal display 330. Then, the destination recognizer 361 of the terminal unit 300 recognizes the setting input by the user's input operation (Step S101).

Then, the destination recognizer 361 acquires point information 510 related to the destination recognized in step S101 (Step S102). Thereafter, the destination recognizer 361 acquires position information 511 related to the destination from the point information 510 (Step S103), and then, acquires point additional information 513 related to the destination from the point information 510 (Step S104).

Furthermore, the destination recognizer 361 acquires name information 521 from the acquired point additional information 513 (Step S105) and also acquires destination position information 522 from the acquired position information 511. Then, destination information 520 related to the destination is generated from the name information 521 and the destination position information 522 (Step 106).

The destination information 520 generated herein is converted to a terminal signal St by a communication line connecting section 310 and then transmitted to the recorder 400 through the network 200 (Step 107).

Next, the keyword generating process of the recorder 400 will be described with reference to FIG. 18.

The network interface 440 of the recorder 400 receives the terminal signal St transmitted from the terminal unit 300 at the network interface 440 (Step S111). Then, the terminal signal St is converted to a process recording device signal Str by the network interface and then transmitted to the CPU 470.

The point information recognizer 471 acquires the destination information 520 included in a process terminal signal Stt. Then, the point information recognizer 471 generates keyword information 543B based on the destination information 520 (Step S112). More specifically, a keyword 543C is generated based on the name information 521 of the destination information 520, and a keyword additional information 543D is generated based on the destination position information 522.

After that, the point information recognizer 471 registers the keyword information 543B generated in the step S112 to the keyword information group 543 (Step S113), and then updates a keyword information number 543A with increasing, for example by one (Step S114).

Next, the timer recording processing of the recorder 400 will be described with reference to FIG. 19.

The recorder 400 executes the timer recording processing when the keyword information group 543 stored in the hard disk 450 of the recorder 400 is updated by the processing of steps S111 to S114, or a new program associated information 542 is acquired at the image/sound composite section 430 by receiving broadcast wave by the tuner 420 (Step S121). The processing will not be executed if the keyword information group 543 has not been updated or if the program associated information 542 has not been updated.

When the timer recording processing is executed in the step S121, first, the CPU 470 initializes internal variable n (Step S122). The internal variable n is a processing variable to execute the recording process sequentially. More specifically, the internal variable n is initialized and an initial value is set to 1. Although the foregoing embodiment exemplifies a case setting the initial value to 1, however, the initial value is not limited to this example.

Then, the timer recording unit 473 compares the internal variable n with the keyword information number 543A (Step S123). When the internal variable n is larger than the keyword information number, the process will be ended.

On the other hand, when the internal variable n is not over the keyword information number at step S123, the timer recording unit 473 acquires the keyword information 543B of the keyword information group 543. Thereafter, the timer recording unit 473 acquires the keyword information 543B described in n-th region from the first information of keyword information 543B in the keyword information group 543. (Step S124) The keyword information 543B described in the n-th region is hereinafter referred to as target keyword information. In the step 124, although the foregoing embodiment exemplifies a case in which the timer recording unit 473 acquires the n-th keyword information 543B described counted from the first keyword information 543B described in the keyword information group 543, however, the invention is not limited to this example. The timer recording unit 473 may acquire the n-th latest keyword information 543B sorted in order of update date and time. Thus, the selection method of the keyword information 543B is not limited.

Thereafter, the timer recording unit 473 acquires the program associated information 542 recorded in the hard disk 450. Then, the timer recording unit 473 sets the entire or a part of the program associated information 542 as the scope of retrieval, and then selects a program described at the top of the scope of retrieval (Step S125). The selected program hereinafter referred to as target program. Thereafter, the timer recording unit 473 acquires the program information related to the target program from the program associated information 542 (Step S126).

Thereafter, the timer recording unit 473 retrieves whether the target keyword information is included in the program information of the target program acquired in the step S126 (Step S127). At this time, a keyword 543C included in the target keyword information is referred to, and checked and retrieved whether the keyword 543C is described in the program information of the target program.

In the step S127, if the target keyword information is not included in the target program, the timer recording unit 473 changes the target program (Step S128). More specifically, the timer recording unit 473 sets the target program described next to the previous target program described in the program associated information 542 to be a new target program.

In the step S127, if the target keyword information is included in the target program, the timer recording unit 473 checks whether the same program has already been described or not by referring to the timer recording information group 544 (Step S129). More specifically, the timer recording unit 473 retrieves the information of the timer recording basic information 544C of the timer recording information 544B described in the timer recording information group 544, such as broadcasted date, start and end time, a station channel information and a name of the program sequentially.

Then, if the timer recording information having the same program information has been registered in the timer recording information group 544 in step S129, the target keyword information is added to the keyword information 544D of the timer recording information 544B having being registered. (Step S130) Thereafter, the process proceeds to step S128, and updates the target program. In addition, if the target keyword information has been already registered in the timer recording information 544B in the step S130, proceed to step S128 without executing any process.

In the step S129, if the timer recording information having the same program information is not registered in the timer recording information group 544, the timer recording unit 473 generates new timer recording information (Step S131). More specifically, the timer recording unit 473 acquires program information of the target program from the program associated information 542. As the program information acquired herein, the information such as broadcasted date, start and end time, channel information of the station and program name can be exemplified. The timer recording basic information based on this program information is generated. Also, the timer recording unit 473 generates the keyword information 544D of the timer recording information 544B based on the target keyword information. The timer recording basic information may include various setting information such as image quality while recording. In this case, for example, it may be so configured that a setting input related to various settings in recording is received at the terminal input section 320 of the terminal unit 300, and then this setting input and the destination information 520 are sent to the recorder 400.

After that, the timer recording unit 473 registers the timer recording information 544B generated in the step S131 to the timer recording information group 544 (Step S132), and then updates the timer recording information number 544A with increasing, for example, by one (Step S133). Thereafter, the process proceeds to the step S128, and updates the target program.

In addition, in the step S128, after updating the target program, the timer recording unit 473 determines whether the entire target program has been retrieved (Step S133). If an unretrieved target program exists in the step S133, the process returns to the step S126, the program information of the target program is acquired again. On the other hand, in the step S133, if the entire program information of the target program is retrieved, the process returns to the step S123 with increasing the internal variable n, for example, by one. As described above, a loop processing is executed so as to search the program information of the program associated information 542 for the entire keyword information 543B registered in the keyword information group 543.

Thereafter, the recording unit 475 executes recording processing of a broadcast program based on the timer recording information 544B registered in the timer recording information group 544. Then, based on the recorded program, the above-described recorded contents information 546 and recorded program information group 545 are generated. Then, the recording unit 475 appropriately sends the generated recorded program information 545B to the terminal unit 300.

Next, the display processing of the contents list 333 in the terminal unit 300 will be described with reference to FIG. 20.

When the communication line connecting section 310 of the terminal unit 300 receives the terminal signal St from the recorder 400, the communication line connecting section 310 converts the signal to a processing terminal signal Stt and sends to the processor 360. The recording information recognizer 364 of the processor 360 acquires recorded program information 545B described in the processing terminal signal Stt (Step S141).

Thereafter, the recording information recognizer 364 acquires destination position information 531 based on the acquired recorded program information 545B (Step S142), and recognizes map information corresponding to this destination position information 531 (Step S143). More specifically, the recording information recognizer 364 recognizes keyword information 545E described in the recorded program information 545B. Then, the recording information recognizer 364 reads the point additional information 513 described in the point information 510 stored in the storage, and then, retrieves and acquires the point additional information 513 that matches with the keyword information 545E. Thereafter, the recording information recognizer 364 acquires the position information 511 and map display data 512 both corresponding to the point additional information.

Next, the recording information recognizer 364 generates the contents list information 530 shown in FIG. 10 based on the destination position information 531, the map display data 512, and the recorded program information 545B acquired in the steps S142 and S143 (Step S144). More specifically, the recording information recognizer 364 generates the contents list information 530 having the destination position information 531, recorded program ID information 532, recorded program basic information 533 and the name information 534 based on the destination position information 531, the recorded program ID information 545C of the recorded program information 545B, the recorded program basic information 545D and the keyword information 545E acquired in the step S142.

The recording information recognizer 364 makes the display controller 363 execute a processing to display a program confirmation icon on the terminal display 330. (Step S145) More specifically, as shown in FIG. 9, the recording information recognizer 364 displays the program confirmation icon superposed in the vicinity of the destination on the map information based on the position information indicated in the destination position information 531 of the contents list information 530.

After that, if the information of selecting the program confirmation icon is input from the terminal input section by the user, the contents list 333 as shown in FIG. 9 is displayed on the display (Step S146).

[Effect of Information Processing System]

As described hereinbefore, in the present embodiment, the terminal unit 300 includes the storage storing the map information, the destination recognizer 361 acquiring the destination information 520, and the recorder 400 includes the tuner for acquiring the program associated information 542, the timer recording unit 473 for generating the key word information 543B from the destination information 520 and retrieving the program information of a broadcast program containing the keyword information 543B in the program associated information 542 to acquire the timer recording information 544B, and the recording unit for recording the broadcast program in the hard disc 450 according to the timer recording basic information 544C of the timer recording information 544B and acquiring the recorded program information 545B related to the recorded program. When the recorded program information 545B is transmitted from the recorder 400 to the terminal unit 300, the display controller 363 of the terminal unit 300 makes the terminal display 330 display a message that the broadcast program related to the destination information has been recorded based on the recorded program information 545B.

Thus, the recorder can record the broadcast program based on the destination information by the input operation of the user for information related to the destination from the map information displayed on the terminal display 330 of the terminal unit 300. Furthermore, the recorder sends the recorded program information to the terminal unit 300 to display on the terminal display 330 of the terminal unit 300, so that the recorded broadcast program can be informed to the user immediately. Therefore, the user has no need to setup the timer recording again with the recorder 400. Furthermore, since the recorder 400 retrieves the broadcast program from program associated information based on the destination information to record, the user has no need to check the broadcast program. Thus, the timer recording of the broadcast program is easily performed. Furthermore, when the recording is completed, a program recording completion message will be indicated on the terminal display 330, thus the user can check the recorded program immediately.

Furthermore, in the embodiment of the present invention, the terminal unit 300 and the recorder 400 are connected so that the can mutually communicate through the network 200. Therefore, even in a case where the terminal unit 300 and the recorder 400 are placed far apart, for example, a car navigation device is used as the terminal unit 300, and a hard disk recorder placed in a house is used as the recorder 400, the information can be communicated through the network 200. Thus, the setting of the timer recording can be performed from any location.

Furthermore, since the program associated information acquirer 472 receives the broadcast wave transmitted from a broadcast station and acquires the program associated information 542 included in the wave, for example, the EPG information can be used so that there is no need to create new program associated information.

The timer recording unit 473 generates the timer recording information 544B by retrieving the program information which has a description matching with the keyword information 543B from the program associated information 542 and registers to the timer recording information group 544. The recording unit 475 records the timer recording information 544B registered in the timer recording information group 544 sequentially. Thus, when a plurality of program information related to the keyword information 543B is acquired, the timer recording information 544B based on the information of the broadcast program can be registered to and stored up in the timer recording information group 544. Thus, the broadcast program related to the keyword information 543B can be securely recorded.

### Modification of Embodiment

The present invention is not limited to the above-mentioned embodiment, but includes improvements and modifications as long as an object of the present invention can be achieved.

In the present embodiment, although the program associated information 542 included in the broadcast wave is acquired by receiving the wave from the antenna 480 connected to the tuner 420, but the receiving method is not limited thereto. The program associated information 542, for example, may be received through network such as internet from the network interface 440.

Further, in the present embodiment, although the terminal unit 300 and recorder 400 have are separately configured and communicated through the network, but the configuration is not limited thereto. For example, the terminal unit 300 and the recorder 400 can be integrated to be one device. In this case, a communicator may be configured from a bus inside of the device, etc. As a result, intersectional parts of both devices can be shared, so that the device can be down sized. In addition, since the device does not require an external device, the processing speed can be improved.

In the present embodiment, although the terminal unit 300 has the display controller 363, the display controller 363 displaying the map information on the terminal display 330 to notify, but the configuration is not limited thereto. For example, the terminal unit 300 may include an audio controller and an audio output to notify the geographic information by sound. Furthermore, the terminal unit 300 may display the map information on the terminal display 330 by the display controller 363, while notifies by sound.

In the present embodiment, although the map information is used as the geographic information, but the geographic information is not limited thereto. The geographic information may be, for example, a route map or a time table of a train, a bus and an airplane, or name information acquired from the terminal unit controlling guide information of travel vendors or accommodations. In this way, wider range of keyword can be acquired and convenience for users is improved.

Also in the present embodiment, although the recorder 400 generates the timer recording information 544B at the timer recording unit 473, and executes the timer recording based on the timer recording information 544B, but the configuration is not limited thereto. For example, the configuration may allow the timer recording unit 473 of the recorder 400 to immediately make the recording unit 475 record the program without generating the timer recording information 544B when the program information being currently broadcasted is found during retrieving the program related to the keyword information.

With such configuration, the processing speed can be improved because the timer recording processing is omitted. Further, the program being currently broadcasted will not be missed and recorded.

Furthermore, if the contents relevant to the keyword information exist in the program being watched, the recording process may start at the time. With such configuration, the user may have more chance to acquire the program other than the program associated information, resulting in improving convenience of the user.

In the present embodiment, although the destination information 520 is generated by acquiring a user-specified point as the name information, however, the destination information is not limited thereto. The destination information 520 may be generated by acquiring the name information existing in the predetermined area from the specified destination point, e.g., the name information of the point information included within 1 km radius. Also, the surrounding area of the destination may be acquired by input operation of the user. Furthermore, the point information of the surrounding area of the destination may be appropriately selected so that it can be acquired by input operation of the user at the terminal input section 320.

As described above, by making the point information of the surrounding area of the destination into the destination information, the keyword information of the program retrieved by the recorder 400 is increased in number. Thus, if a program does not contain a keyword regarding the destination in the program information, for example, the program can be recorded as long as the program contains the point information of the surrounding area as the program information. Therefore, since a program including the surrounding area of the destination can be retrieved without limiting to the destination, more programs are retrieved so that more suitable program can be found for the user.

Furthermore, since a program related to information of a position at the surrounding area of the destination, where the user has not known, can be retrieved, a useful piece of information can be acquired when planning a travel.

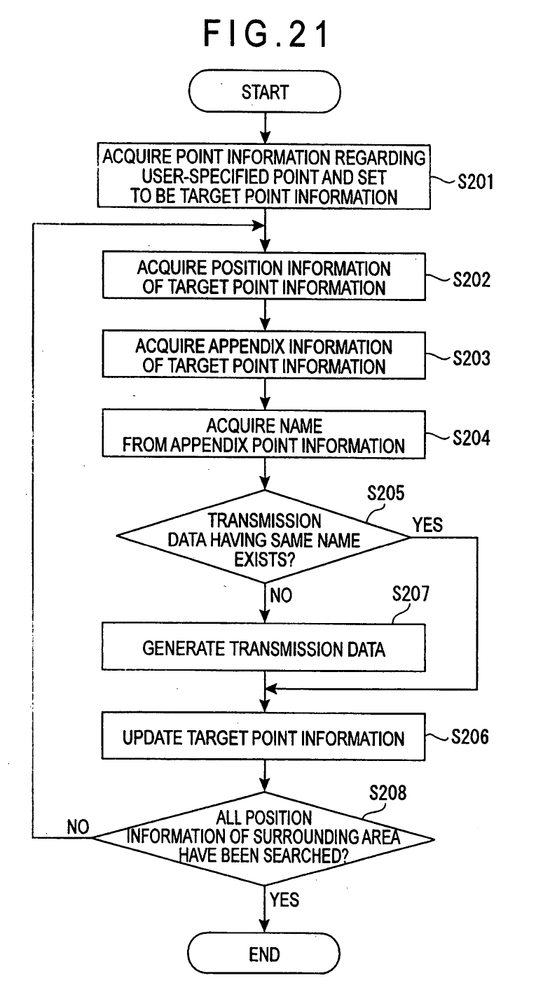

In this case, the processing S102 to S106 of the destination information in the terminal unit 300 can be replaced with the processing shown in FIG. 21, for example. In FIG. 21, firstly, the terminal unit 300 acquires the point information related to the destination based on the settings input by the user at the terminal input section 320 (Step S201). Herein, the target point information means temporary point information currently targeted.

Then the destination recognizer 361 acquires the position information of the targeted point information from the point information 510 (Step S202), and acquires the point additional information 513 of the targeted point (Step S204). Then, the destination recognizer 361 also acquires name information from the acquired point additional information 513 (Step S204). Herein, the destination recognizer 361 determines whether data having the same name information exists or not (Step S205). In the step S205, if the data having the same name information exist, the targeted point information is updated (Step S206). On the other hand, if there are no data having the same name information, the destination information is generated (Step S207), and then proceeds to the step S206 to update the targeted point information. Thereafter, the destination recognizer 361 determines whether all point information at the surrounding area of the destination is checked (Step S208), and return to the step S202 if any unchecked point information exist.

As described above, by changing the acquisition processing of the destination information 520, duplication of keyword information made by generating the destination information having the same name can be avoided. Accordingly, unnecessary memory capacity and processing can be reduced, efficiency of processing can be improved.

Furthermore, a navigation device, for example, may be applicable as the terminal unit 300, which enables the route searching from the departure position to the final destination. In this case, the terminal unit may have, for example, a departure recognizer recognizing the departure position information as a first geographic information, the destination recognizer 361 recognizing destination position information as a second geographic information, and a travel route searcher acquiring a route as travel route information by searching a travel route from the departure position to the final destination, and the like. The destination recognizer 361 is configured to acquire the point information existing on the route between the departure position and the destination acquired bu the route searching unit to generate the destination information based on these point information. Furthermore, the configuration may allow acquiring the name information by selecting a desired point for a user to drop in, on the searched route by the searching unit. Also, there may be made another configuration allowing acquiring the point at the surrounding area on the route to recognize them as destination information.

With such configurations, information on the travel route to the destination can be recorded on the recorder 400 when making a travel plan, and thus various point information on the travel route in addition to the information of the final destination can be acquired. Thus, a travel plan can be laid out more effectively.

Furthermore, a configuration may allow providing the additional information such as the priority or category information to each of the point additional information 513 of the point information 510. With such configuration, for example, the point information lower than a predetermined priority level may be filtered out by a setting of the user's input, or only the point information under the predetermined category may be acquired. This allows filtering the name information depending on priority and the category information so that the name information meeting user demands can be acquired. Thus, the recording of programs useless for the user can be avoided, and the number of program confirmation icon 332 superposed and displayed on the map information can be properly adjusted. Also, the memory space efficiency and processing efficiency can be improved.

Furthermore, in the present embodiment, although the information related to the destination is acquired by operation of the user, however, the invention is not limited thereto. For example, keywords may be extracted based on preset travel information, in a case, for example, a car navigation device is employed for the terminal unit 300. Also, if there is a point or route having been traveled by many times, there may be made such a configuration that the keyword may be extracted for the frequently-traveled point or route.

With such configuration, the program related to routes and points familiar to the user can be recorded. Thus, by recording information of the point or the route as well as recording the program interested by the user, the user can possibly acquire more detailed information which the user has not known, so that user-friendliness can be improved.

In the present embodiment, although the recording information recognizer 364 acquires contents list information based on the recording information transmitted from the recorder 400 to the terminal unit 300, however, the configuration is not limited thereto. For example, the recording information recognizer 364 may receive only the information indicating that recording has been completed from the recorder 400, display a program confirmation icon 332 on the terminal display 330, and link to the recorded program information 545B recorded in the recorder 400 when the program confirmation icon 332 is selected by the user.

In the present embodiment, although the timer recording unit 473 acquires the n-th keyword information 543B from the top of the keyword information 543B described in the keyword information group 543 in the step S125, but the configuration is not limited thereto. For example, timer recording unit 473 may acquire the n-th latest keyword information 543B sorting in order of update date and time, that is, the selection method of the keyword information 543B is not limited.

Also, in the present embodiment, although the terminal unit 300 generates the contents list information 530 receiving a recorded program information, and displays the program confirmation icon 332 on the terminal display 330 to display the contents list 333 based on the contents list information 530 once input to select the program confirmation icon 332 is sent from the terminal input section 320. However, the invention is not limited thereto. For example, a configuration may allow playing back the contents of the recorded program shown in the contents list information 530 once input to select the program confirmation icon 332 is sent. Also, a configuration may allow playing back the contents of the recorded program shown in the contents list information 530 once input to select the program information desired by the user from the contents list 333 displayed on the terminal display 330 is received. In this case, the contents of the recorded program is played back after sending the recorded program from the recorder 400 to the terminal unit by streaming process, or the like. Thus, the user can immediately recognize and watch the recorded program on the terminal display 330 of the terminal unit 300. Also, when a navigation device is used for the terminal unit 300, contents of the recorded program can be played back and watched at the travel destination by using the terminal unit. Furthermore, as described above, when a device in which the terminal unit 300 and the recorder 400 are integrated is used, the communication speed between these devices is improved, and the contents can be played back more comfortably.

### Effect of Embodiment

As described above, in the present embodiment, the terminal unit 300 includes a storage storing map information and a destination recognizer 361 acquiring destination information 520. The recorder 400 generates keyword information 543B includes the tuner for acquiring the program associated information 542, the timer recording unit 473 for generating the key word information 543B from the destination information 520 and retrieving the program information of a broadcast program containing the keyword information 543B in the program associated information 542 to acquire the timer recording information 544B, and the recording unit for recording the broadcast program in the hard disc 450 according to the timer recording basic information 544C of the timer recording information 544B and acquiring the recorded program information 545B related to the recorded program. Thereafter, when the recorded program information 545B is transmitted from the recorder 400 to the terminal unit 300, the display controller 363 of the terminal unit 300 displays a message that the broadcast program relevant to the destination information has been recorded on the terminal display 330, based on recorded program information 545B.

Thus, the recorder can record the broadcast program based on the destination information by putting information related to th destination by the user from the map information displayed on the terminal display 330 of the terminal unit 300. Furthermore, the recorder sends the recorded program information to the terminal unit 300 to display on the terminal display 330 of the terminal unit 300, thus the recorded broadcast program can be immediately notified to the user.

The priority application Number JP2004-006852 upon which this patent application is based is hereby incorporated by reference.

1. An information processing system comprising: a terminal unit; a recording device for recording a broadcast program; and a communicator for connecting the terminal unit and the recording device to enable communication therebetween,
wherein the terminal unit includes:
a geographic information storage for storing geographic information;
a transmitter for transmitting geographic identifying information indicating a specific position within the geographic information to the recording device through the communicator, and
wherein the recording device includes:
a receiver for receiving the geographic identifying information transmitted from the terminal unit;
a broadcast program information acquirer for acquiring broadcast program information related to the broadcast program;
a target program information acquirer for acquiring target program information from the broadcast program information based on the received geographic identifying information.

2. The information processing system according to claim 1, wherein
the geographic identifying information is a geographic name.

3. The information processing system according to claim 1, wherein
the geographic identifying information is a position information.

4. The information processing system according to claim 1, wherein
the terminal unit has a geographic information acquirer for acquiring a first geographic information related to a departure position and a second geographic information related to a destination position, and
a travel route searcher for searching a sectional travel route indicated by the first geographic information and the second geographic information on the geographic information so as to acquire travel route information; and
the geographic identifying information is included in the travel route information.

5. The information processing system according to claim 4, wherein
the terminal unit has an input unit for inputting the geographic identifying information; and
the geographic information acquirer acquires the first geographic information and the second geographic information based on the geographic identifying information input from the input unit.

6. The information processing system according to claim 1, comprising:
a target program recording unit for recording a target program corresponding to the target program information on a recording medium; and
target program information recording unit for recording information related to the target program.

7. The information processing system according to claim 1, wherein
the recording device has a target program timer recording unit for generating timer recording information based on the target program information, so as to record the broadcast program based on the timer recording information.

8. The information processing system according to claim 1, comprising:
a display controller for controlling a display unit to display the geographic information.

9. The information processing system according to claim 8, wherein
the display controller controls the display unit to display the target program information acquired by the recording device.

10. The information processing system according to claim 1, wherein
the broadcast program information acquirer receives broadcast wave transmitted from a broadcast station, and acquires program associated information included in the broadcast wave.

11. The information processing system according to claim 1, wherein
the geographic information acquirer recognizes information related to surrounding areas of a position indicated by the geographic identifying information, and acquires the geographic identifying information related to the surrounding areas simultaneously when recognizing one geographic identifying information.

12. A terminal unit adapted to be connected with a recording device recording broadcast program through a communicator, comprising:
a geographic information storage for storing geographic information; and
a transmitter for transmitting geographic identifying information to the recording device through the communicator, the geographic identifying information indicating a specific position within the geographic information, being used for the recording device to acquire target program information from information related to the broadcast program information.

13. A recording device adapted to be connected with a terminal unit through a communicator, the terminal unit including:
a geographic information storage for storing geographic information; and
a transmitter for transmitting geographic identifying information to the recording device through the communicator, the geographic identifying information indicating a specific position within the geographic information, being used for the recording device to acquire target program information from information related to the broadcast program information,
wherein the recording device comprises:
a receiver for receiving geographic identifying information to be acquired and to be transmitted by the terminal unit;
a broadcast program information acquirer for acquiring broadcast program information related to the broadcast program; and
a target program information acquirer for acquiring target program information from the broadcast program information based on the received geographic identifying information.

14. An information processing method comprising the steps of:
acquiring geographic identifying information indicating a specific position from geographic information at a terminal unit;
transmitting the acquired geographic identifying information from the terminal unit to a recording device through a communicator; and
acquiring broadcast program information related to a broadcast program, and then acquiring a target program information from the broadcast program information based on the received geographic identifying information at the recording device.

15. An information processing program causing a computer to execute an information processing method, the method comprising the steps of:
acquiring geographic identifying information indicating a specific position from geographic information at a terminal unit;
transmitting the acquired geographic identifying information from the terminal unit to a recording device through a communicator; and
acquiring broadcast program information related to a broadcast program, and then acquiring target program information from the broadcast program information based on the received geographic identifying information at the recording device.

16. A recording medium storing an information processing program in a manner readable by the computer, the information processing program causing a computer to execute an information processing method which comprises the steps of:
acquiring geographic identifying information indicating a specific position from geographic information at a terminal unit;
transmitting the acquired geographic identifying information from the terminal unit to a recording device through a communicator; and
acquiring broadcast program information related to a broadcast program, and then acquiring target program information from the broadcast program information based on the received geographic identifying information at the recording device.
